(19) United States
(12) Patent Application Publication
(10) Pub. No.: US 2012/0327039 A1
(43) Pub. Date: Dec. 27, 2012

(54) INFRARED TOUCH SCREEN WITH SIMPLIFIED COMPONENTS

(75) Inventor: Dax KUKULJ, Summer Hill (AU)

(73) Assignee: RPO PTY LTD, Acton (AU)

(21) Appl. No.: 13/534,743

(22) Filed: Jun. 27, 2012

(30) Foreign Application Priority Data
Jun. 27, 2011 (AU) 2011902518

(51) Int. Cl. G06F 3/042

(52) U.S. Cl. 345/175

(57) ABSTRACT

We present signal production devices and infrared-style touch screens incorporating them. Compared to prior art devices, the signal production devices of the present invention have simpler, more easily manufactured components. Touch screens incorporating these devices can have reduced bezel width, and are particularly well-suited to finger-only touch on small area screens.

### FIELD OF THE INVENTION

The present invention relates to touch screens, and in particular to infrared-style touch screens having simplified components, reduced bezel dimensions and/or lower cost. However, it will be appreciated that the invention is not limited to this particular field of use.

### BACKGROUND OF THE INVENTION

Any discussion of the prior art throughout the specification should in no way be considered as an admission that such prior art is widely known or forms part of the common general knowledge in the field.

Input devices based on touch sensing (commonly referred to as touch screens irrespective of whether the input area corresponds with a display screen) have long been used in electronic devices such as computers, personal digital assistants (PDAs), handheld games and point of sale kiosks, and are now appearing in other portable consumer electronics devices such as mobile phones. Generally, touch-enabled devices allow a user to interact with the device by touching one or more graphical elements, such as icons or keys of a virtual keyboard, presented on a display, or by writing on a display or pad. Several touch-sensing technologies are known, including resistive, surface capacitive, projected capacitive, surface acoustic wave, optical and infrared, all of which have advantages and disadvantages in areas such as cost, reliability, ease of viewing in bright light, ability to sense different types of touch object, e.g. finger, gloved finger or stylus, and single or multi-touch capability.

Infrared touch screens typically detect touch events by the blocking or shadowing of paths of light, usually but not necessarily in the infrared portion of the spectrum. As shown in plan view in FIG. 1 the earliest forms of infrared-style touch screens 2, described for example in U.S. Pat. No. 3,478,220 and U.S. Pat. No. 3,673,327, included arrays of discrete optical sources 4 (e.g. LEDs) along two adjacent sides of a rectangular input area 6 emitting two sets of parallel beams of light 8 towards opposing arrays of photo-detectors 10 along the other two sides of the input area. If a touch object 12 in the input area blocks a substantial portion of at least one beam in each of the two axes, its location can be readily determined.

FIG. 2 shows in plan view a variant infrared-style touch screen 14 with far fewer optoelectronic components, described in published US patent application No 2008/0278460 A1 entitled ‘A transmissive body’, the contents of which are incorporated herein by reference. In this form of infrared touch screen the ‘transmit’ optics comprise a pair of optical sources 4, e.g. infrared LEDs, and a transmissive body 16 that converts the divergent light 17 from the optical sources into two in-plane collimated sheets of light 18 for sensing a touch object 12 located within the input area 6. The ‘receive’ optics comprise an array of optical waveguides 20 and in-plane lenses 22 integrated on an L-shaped substrate 24 and a multi-element detector 26 such as a line camera or a digital camera chip. Portions of the light sheets are collected by the in-plane lenses and guided by the waveguides to one or more pixels of the detector array. The transmit and/or receive optics may also include cylindrically curved vertical collimating lenses (VCLs, not shown in FIG. 2) to collimate the signal light in the out-of-plane direction. For simplicity FIG. 2 only shows three waveguides and in-plane lenses per axis; in actual touch screens the in-plane lenses will be sufficiently closely spaced such that the smallest likely touch object will substantially reduce the amount of light collected by at least one lens in each axis.

The transmissive body 16 is an important component of the touch screen 14, and can take a variety of forms. In the form shown in FIGS. 3A (plan view) and 3B (cross-sectional side view through line A-A′) it comprises a light guide plate 30 and two substantially parabolic collimation/redirection elements 32 formed as a unitary body. In operation, divergent light 17 from the optical sources 4 is launched into the light guide plate, then collimated and redirected back across the front surface of the light guide plate to form the light sheets 18. It will be appreciated that provided each optical source is positioned at or near the focal point of the corresponding parabolic collimation/redirection element, the light sheets will be collimated in the plane of the light guide plate. In an alternative form shown in FIG. 4 (cross-sectional side view) the parabolic collimation/redirection elements 32 are formed separately and attached to the light guide plate 30, e.g. with double-sided pressure-sensitive tape 36, to provide the transmissive body 16. In yet another form, shown in FIG. 5 (plan view, showing a single axis only for simplicity), the collimation function of the transmissive body 16 is performed by a substantially elliptical lens 38, with an optical source 4 located at a focus of the lens.

Whether the collimation is performed by a parabolic reflector or an elliptical lens, inspection of FIGS. 3A and 5 shows that the in-plane curvature of the collimation/redirection elements causes them to extend a distance 40 beyond the usable touch input area. This distance may impose a limit on the narrowness of the bezel of a touch screen-equipped device, or for a given device package size it may limit the available touch input area. Also, the collimation/redirection elements are relatively complex shapes and it can be difficult to manufacture them with sufficient precision using rapid and inexpensive techniques, such as injection moulding, for use in consumer electronics devices. The distance 40 can be significantly reduced by using a segmented reflector or lens as described in US 2008/0278460 A1, but these more complex shapes are also difficult to manufacture accurately.

### OBJECT OF THE INVENTION

It is an object of the present invention to overcome or ameliorate at least one of the disadvantages of the prior art, or to provide a useful alternative. It is an object of the invention in its preferred form to provide infrared-style touch screens with reduced bezel width on at least some sides of the input area. It is another object of the invention in its preferred form to improve the manufacturability of certain components of infrared-style touch screens.

### SUMMARY OF THE INVENTION

According to a first aspect of the present invention there is provided a signal production device for a touch screen, said signal production device comprising a transmissive body and a first optical source, wherein said transmissive body comprises:
(a) a substantially planar light guide plate adapted to receive a divergent optical signal from said first optical source and confine and transmit said optical signal; and
(b) a redirection element adapted to redirect said optical signal to produce a first sheet of light propagating and diverging in a first plane substantially parallel to said light guide plate.

In a preferred form the redirection element is positioned along a first side of the light guide plate, and the first optical source launches the divergent optical signal through a second, opposing side of the light guide plate towards the redirection element such that the first sheet of light overlies at least part of a surface of said the guide plate.

Preferably, the signal production device further comprises a second optical source spaced apart from the first optical source and positioned to launch a second divergent optical signal through the second side of the light guide plate towards the redirection element so as to produce a second sheet of light propagating and diverging in the first plane, wherein the second sheet of light overlies at least part of the surface and has a substantial overlap region with the first sheet of light.

Alternatively, the signal production device further comprises: a second redirection element positioned along a third side of the light guide plate; and a second optical source positioned to launch a second divergent optical signal through a fourth side of the light guide plate towards the second redirection element so as to produce a second sheet of light propagating and diverging in a second plane substantially parallel to the light guide plate, wherein the second sheet of light overlies at least part of the surface and has a substantial overlap region with the first sheet of light. Preferably, the first and second planes are the same plane.

Preferably, the light guide plate and the redirection element are formed separately and assembled together. More preferably, the redirection element is an elongate turning prism.

According to a second aspect of the present invention there is provided a signal production device for a touch screen, said signal production device comprising: a substantially planar light guide plate; a redirection element positioned along a first side of said light guide plate; and first and second optical sources positioned spaced apart from each other along a second, opposing side of said light guide plate, wherein:

said first and second optical sources launch first and second divergent optical signals through said second side towards said redirection element, such that said redirection element redirects said first and second optical signals to produce first and second sheets of light propagating and diverging in a plane substantially parallel to said light guide plate, wherein said first and second sheets of light each overlie at least part of a surface of said light guide plate and have a substantial overlap region.

According to a third aspect of the present invention there is provided a signal production device for a touch screen, said signal production device comprising: a substantially planar light guide plate; first and second redirection elements positioned along adjacent first and third sides of said light guide plate; and first and second optical sources, wherein:

said first optical source launches a divergent first optical signal through a second side of said light guide plate towards said first redirection element and said second optical source launches a divergent second optical signal through a fourth side of said light guide plate towards said second redirection element, such that said first redirection element redirects said first optical signal to produce a first sheet of light propagating and diverging in a first plane substantially parallel to said light guide plate and said second redirection element redirects said second optical signal to produce a second sheet of light propagating and diverging in a second plane substantially parallel to said light guide plate, wherein said first and second sheets of light each overlie at least part of a surface of said light guide plate and have a substantial overlap region.

Preferably, the first and second planes are the same plane.

According to a fourth aspect of the present invention there is provided a signal production device for a touch screen, said signal production device comprising: a substantially planar light guide plate; first and second redirection elements positioned along adjacent first and third sides of said light guide plate, said first and third sides extending from a first corner of said light guide plate; and a first optical source positioned proximate a second corner of said light guide plate, opposite said first corner, wherein:

said first optical source launches a divergent first optical signal into said light guide plate towards said first and second redirection elements, such that said first redirection element redirects a first part of said first optical signal to produce a first sheet of light propagating and diverging in a first plane substantially parallel to said light guide plate, and said second redirection element redirects a second part of said first optical signal to produce a second sheet of light propagating and diverging in a second plane substantially parallel to said light guide plate, wherein said first and second sheets of light each overlie at least part of a surface of said light guide plate and have a substantial overlap region.

Preferably, the signal production device further comprises second and third optical sources positioned proximate to third and fourth corners of the light guide plate, wherein the second optical source launches a divergent second optical signal into the light guide plate towards the first redirection element to produce a third sheet of light propagating and diverging in the first plane, and the third optical source launches a divergent third optical signal into the light guide plate towards the second redirection element to produce a fourth sheet of light propagating and diverging in the second plane, wherein the third and fourth sheets of light each overlie at least part of the surface. The first and second planes are preferably the same plane.

According to a fifth aspect of the present invention there is provided a touch screen comprising: a signal production device adapted to produce a first diverging sheet of light; and a system of receive optics for receiving portions of said first sheet of light, wherein said signal production device comprises:
(a) a substantially planar light guide plate adapted to receive a divergent optical signal from a first optical source and confine and transmit said optical signal; and
(b) a redirection element adapted to redirect said optical signal to produce a first sheet of light propagating and diverging towards said system of receive optics in a first plane substantially parallel to said light guide plate.

In a preferred form the redirection element is positioned along a first side of the light guide plate, the system of receive optics is positioned along a second, opposing side of the light guide plate, and the first optical source launches the divergent optical signal through the second side towards the redirection element such that the first sheet of light overlies at least part of a surface of the light guide plate. The system of receive optics preferably comprises an optical waveguide array and at least one multi-element detector, wherein the waveguides in the array are adapted to receive portions of the first sheet of light and conduct the portions to the at least one multi-element detector.

In another preferred form the signal production device further comprises a second optical source spaced apart from the first optical source and positioned to launch a second divergent optical signal through the second side of the light guide plate towards the redirection element so as to produce a second sheet of light propagating and diverging towards the system of receive optics in the first plane, wherein the second sheet of light overlies at least part of the surface and has a substantial overlap region with the first sheet of light. The system of receive optics preferably comprises an optical waveguide array and at least one multi-element detector, wherein the waveguides in the array are adapted to receive portions of the first and second sheets of light and conduct the portions to the at least one multi-element detector.

In one preferred form the optical waveguide array comprises interleaved first and second sets of in-plane lenses respectively adapted to receive portions of the first and second sheets of light and focus the portions into corresponding first and second sets of optical waveguides. Preferably, each pair of adjacent first and second optical waveguides feeds into a common waveguide.

In another preferred form the optical waveguide array comprises an array of composite in-plane lenses with associated optical waveguides, wherein each said composite in-plane lens comprises first and second focusing elements adapted to receive portions of the first and second sheets of light and focus the portions into the associated waveguide.

Preferably, the light guide plate and the redirection element are formed separately and assembled together. More preferably, the redirection element is an elongate turning prism.

In one preferred form the signal production device further comprises: a second redirection element positioned along a third side of the light guide plate; and a second optical source positioned to launch a second divergent optical signal through a fourth side of the light guide plate towards the second redirection element so as to produce a second sheet of light propagating and diverging towards the system of receive optics in a second plane substantially parallel to the light guide plate, wherein the second sheet of light overlies at least part of the surface and has a substantial overlap region with the first sheet of light. The system of receive optics preferably comprises one or more optical waveguide arrays and at least one multi-element detector, wherein the waveguides in the one or more arrays are adapted to receive portions of the first and second sheets of light and conduct the portions to the at least one multi-element detector. Preferably, the first and second planes are the same plane.

According to a sixth aspect of the present invention there is provided a touch screen comprising: signal production device adapted to produce first and second diverging sheets of light; and a system of receive optics for receiving portions of said first and second sheets of light, wherein said signal production device comprises:

a substantially planar light guide plate; a redirection element positioned along a first side of said light guide plate; and first and second optical sources positioned spaced apart from each other along a second, opposing side of said light guide plate, wherein:
said first and second optical sources launch first and second divergent optical signals through said second side towards said redirection element, such that said redirection element redirects said first and second optical signals to produce first and second sheets of light propagating and diverging in a plane substantially parallel to said light guide plate, wherein said first and second sheets of light each overlie at least part of a surface of said light guide plate and have a substantial overlap region.

The system of receive optics preferably comprises an optical waveguide array and at least one multi-element detector, wherein the waveguides in the array are adapted to receive portions of the first and second sheets of light and conduct the portions to the at least one multi-element detector.

In one preferred form the optical waveguide array comprises interleaved first and second sets of in-plane lenses respectively adapted to receive portions of the first and second sheets of light and focus the portions into corresponding first and second sets of optical waveguides. Preferably, each pair of adjacent first and second optical waveguides feeds into a common waveguide.

In another preferred form the optical waveguide array comprises an array of composite in-plane lenses with associated optical waveguides, wherein each composite in-plane lens comprises first and second focusing elements adapted to receive portions of the first and second sheets of light and focus the portions into the associated waveguide.

According to a seventh aspect of the present invention there is provided a touch screen comprising: a signal production device adapted to produce first and second diverging sheets of light; and a system of receive optics for receiving portions of said first and second diverging sheets of light, wherein said signal production device comprises:

a substantially planar light guide plate; first and second redirection elements positioned along adjacent first and third sides of said light guide plate; and first and second optical sources, wherein:
said first optical source launches a divergent first optical signal through a second side of said light guide plate towards said first redirection element and said second optical source launches a divergent second optical signal through a fourth side of said light guide plate towards said second redirection element, such that said first redirection element redirects said first optical signal to produce a first sheet of light propagating and diverging in a first plane substantially parallel to said light guide plate and said second redirection element redirects said second optical signal to produce a second sheet of light propagating and diverging in a second plane substantially parallel to said light guide plate, wherein said first and second sheets of light each overlie at least part of a surface of said light guide plate and have a substantial overlap region.

Preferably, the first and second planes are the same plane.

The system of receive optics preferably comprises one or more optical waveguide arrays and at least one multi-element detector, wherein the waveguides in the one or more arrays are adapted to receive portions of the first and second sheets of light and conduct the portions to the at least one multi-element detector.

According to an eighth aspect of the present invention there is provided a touch screen comprising: a signal production device adapted to produce first and second diverging sheets of light; and a system of receive optics for receiving portions of said first and second sheets of light, wherein said signal production device comprises:

a substantially planar light guide plate; first and second redirection elements positioned along adjacent first and third sides of said light guide plate, said first and third sides extending from a first corner of said light guide plate; and a first optical source positioned proximate a second corner of said light guide plate, opposite said first corner, wherein:
said first optical source launches a divergent first optical signal into said light guide plate towards said first and second redirection elements, such that said first redirection element redirects a first part of said first optical signal to produce a first sheet of light propagating and diverging in a first plane substantially parallel to said light guide plate, and said second redirection element redirects a second part of said first optical signal to produce a second sheet of light propagating and diverging in a second plane substantially parallel to said light guide plate, wherein said first and second sheets of light each overlie at least part of a surface of said light guide plate and have a substantial overlap region.

Preferably, the first and second planes are the same plane.

The system of receive optics preferably comprises one or more optical waveguide arrays and at least one multi-element detector, wherein the waveguides in the one or more arrays are adapted to receive portions of the first and second sheets of light and conduct the portions to the at least one multi-element detector.

In a preferred form the signal production device further comprises second and third optical sources positioned proximate to third and fourth corners of the light guide plate, wherein the second optical source launches a divergent second optical signal into the light guide plate towards the first redirection element to produce a third sheet of light propagating and diverging in the first plane, and the third optical source launches a divergent third optical signal into the light guide plate towards the second redirection element to produce a fourth sheet of light propagating and diverging in the second plane, wherein the third and fourth sheets of light each overlie at least part of the surface.

The system of receive optics preferably comprises one or more optical waveguide arrays and at least one multi-element detector, wherein the waveguides in the one or more arrays are adapted to receive portions of the first, second, third and fourth sheets of light and conduct the portions to said at least one multi-element detector. Preferably, the one or more optical waveguide arrays comprise: a first waveguide section positioned along a side of the light guide plate opposite the first redirection element and adapted to receive portions of the first and third sheets of light; and a second waveguide section positioned along a side of the light guide plate opposite the second redirection element and adapted to receive portions of the second and fourth sheets of light.

In one preferred form, the first waveguide section comprises interleaved first and second sets of in-plane lenses respectively adapted to receive portions of the first and third sheets of light and focus the portions into corresponding first and second sets of optical waveguides. Preferably, each pair of adjacent first and second optical waveguides feeds into a common waveguide.

In another preferred form, the first waveguide section comprises an array of composite in-plane lenses with associated optical waveguides, wherein each composite in-plane lens comprises first and second focusing elements adapted to receive portions of the first and third sheets of light and focus the portions into the associated waveguide.

In one preferred form, the second waveguide section comprises interleaved first and second sets of in-plane lenses respectively adapted to receive portions of the second and fourth sheets of light and focus the portions into corresponding first and second sets of optical waveguides. Preferably, each pair of adjacent first and second optical waveguides feeds into a common waveguide.

In another preferred form, the second waveguide section comprises an array of composite in-plane lenses with associated optical waveguides, wherein each composite in-plane lens comprises first and second focusing elements adapted to receive portions of the second and fourth sheets of light and focus the portions into the associated waveguide.

### BRIEF DESCRIPTION OF THE DRAWINGS

Preferred embodiments of the invention will now be described, by way of example only, with reference to the accompanying drawings in which:

FIG. 1 illustrates a plan view of a conventional infrared touch screen with multiple paired optical sources and detectors;

FIG. 2 illustrates a plan view of an infrared touch screen where collimated sheets of sensing light are generated using a specially designed transmissive body;

FIGS. 3A and 3B illustrate in plan view and cross-sectional side view one form of a transmissive body;

FIG. 4 illustrates in cross-sectional side view another form of a transmissive body;

FIG. 5 illustrates in plan view yet another form of a transmissive body;

FIGS. 6A and 6B illustrate in plan view and cross-sectional side view a signal production device according to an embodiment of the invention;

FIGS. 6C and 6D illustrate in side view signal production devices according to embodiments of the invention, with alternative designs for a redirection element;

FIG. 7 illustrates in plan view an infrared touch screen according to an embodiment of the invention;

FIGS. 8A and 8B illustrate light paths within the infrared touch screen of FIG. 7;

FIGS. 9A and 9B illustrate schematically two possible layouts of receive waveguides for use in the infrared touch screen of FIG. 7;

FIG. 10 shows the various touch areas of the infrared touch screen of FIG. 7;

FIGS. 11 and 12 illustrate two possible applications of the infrared touch screen of FIG. 7;

FIG. 13 illustrates in plan view an infrared touch screen according to an embodiment of the invention;

FIG. 14 illustrates in plan view an infrared touch screen according to an embodiment of the invention;

FIG. 15 illustrates in plan view an infrared touch screen according to an embodiment of the invention;

FIGS. 16A and 16B illustrate light paths within the infrared touch screen of FIG. 15;

FIGS. 17A to 17C show the various touch areas of the infrared touch screen of FIG. 15, and their dependence on the separation between the two optical sources;

FIG. 18 illustrates schematically a layout of receive waveguides for use in the infrared touch screen of FIG. 15;

FIG. 19 shows in plan view a composite in-plane lens suitable for collecting portions of two light sheets propagating in different directions;

FIGS. 20A, 20B and 20C illustrate in side view three arrangements for stacking arrays of integrated optical waveguides; and

FIGS. 21 to 23 illustrate in plan view infrared touch screens according to various embodiments of the invention.

### DETAILED DESCRIPTION OF PREFERRED EMBODIMENTS OF THE INVENTION

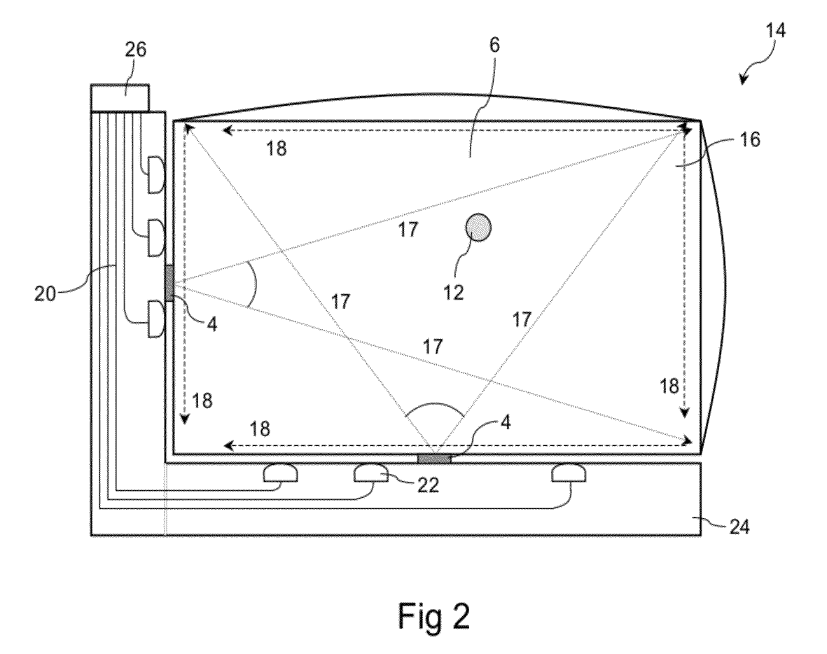

Referring to the infrared touch screen 14 shown in FIG. 2, in can be seen that the presence of collimated light sheets 18 propagating in the X and Y axes provides complete coverage of the input area 6 such that a touch object 12 located anywhere within the input area can be detected, providing the object is sufficiently large and opaque to reduce substantially the amount of light collected by at least one in-plane lens 22 in each axis. However as discussed above the requirement for the transmissive body 16 to have a collimation function also has drawbacks, namely more complicated component manufacture and an increase in bezel width or a reduction in input area size. Surprisingly, we have found that the collimation requirement can be dispensed with for certain applications and/or for certain configurations of optical sources and receive waveguides.

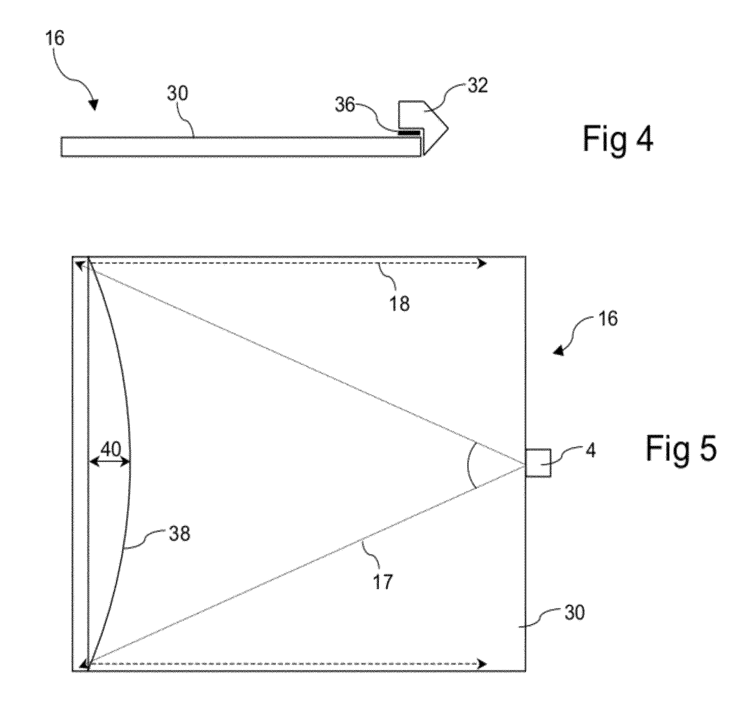

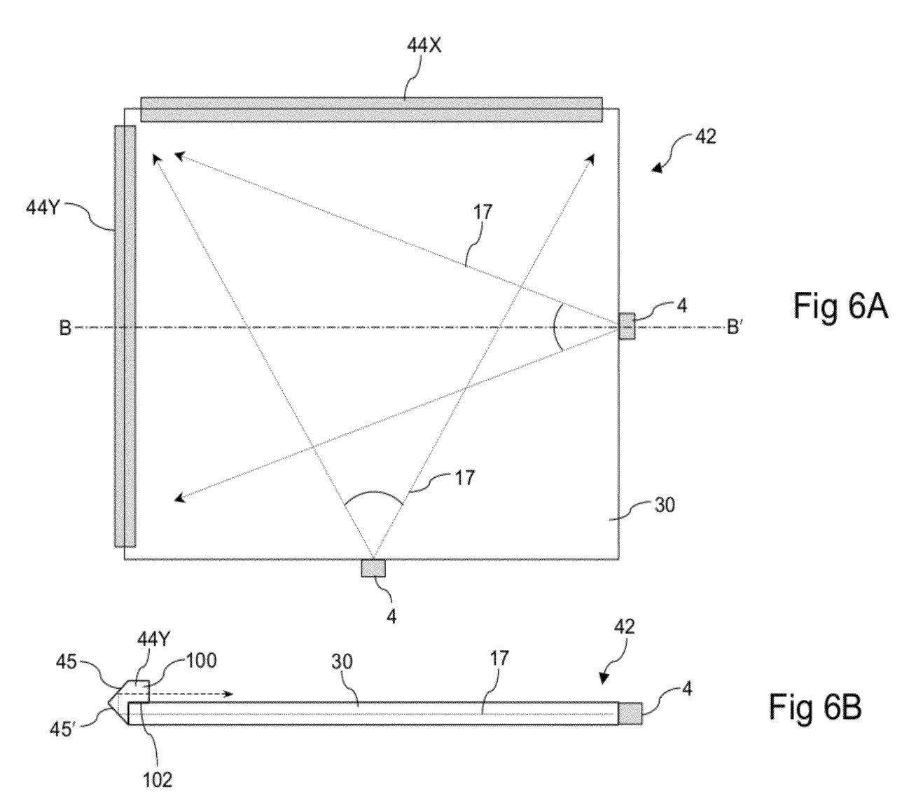

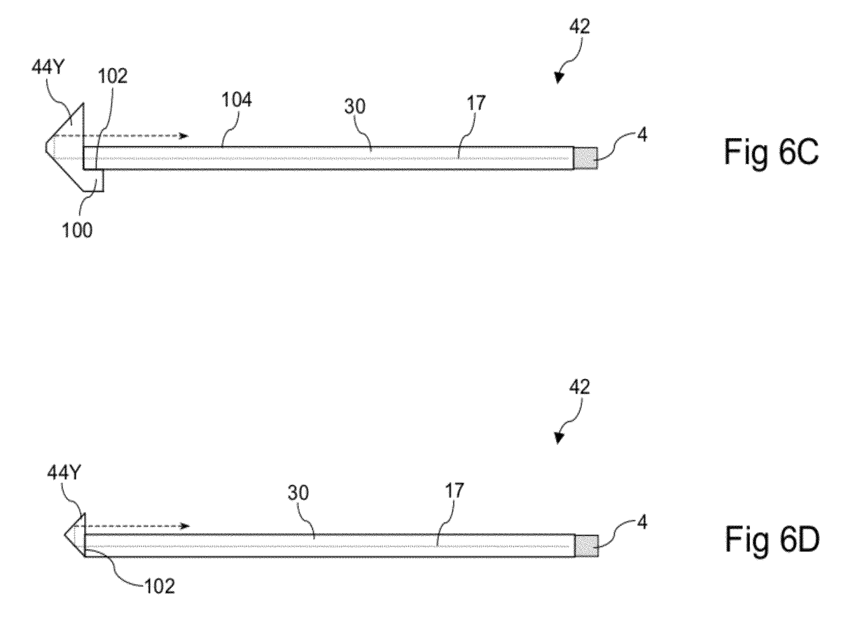

FIGS. 6A (plan view) and 6B (cross-sectional side view through the line B-B′) show an embodiment of a simplified signal production device 42 suitable for use in an infrared touch screen, comprising: a rectangular light guide plate 30 and two redirection elements 44X and 44Y along adjacent sides of the light guide plate; and two optical sources 4 (e.g. LEDs) positioned to launch divergent light 17 into the light guide plate towards the redirection elements. In one embodiment the light guide plate is in the form of a glass sheet and the redirection elements are in the form of elongate turning prisms, formed of injection moulded or extruded plastic for example, attached to the light guide plate in similar fashion to that shown in FIG. 4. As shown in FIG. 6B the divergent light 17 is redirected by specular reflection from two surfaces 45 and 45′ of the redirection element 44Y, with the angle of incidence being 45° on each occasion. If for example the redirection element is composed of a polycarbonate material with refractive index 1.545 at 850 nm, the critical angle at a polycarbonate/air interface will be 40.3°, indicating that the light can be redirected by total internal reflection (TIR). However the surfaces 45 and 45′ can also be metallized is desired, for example if there is a possibility that TIR could be disrupted by condensation on the surfaces.

The ‘pedestal’ portion 100 of the redirection element 44Y as shown in FIG. 6B does not contribute to the light redirection function, but provides an attachment surface 102 (e.g. for double-sided tape 36 as shown in FIG. 4) that is not in the optical path. As shown in FIG. 6C a redirection element 44Y could alternatively be redesigned with the pedestal portion 100 interfacing with the other side of the light guide plate 30 so that it does not obscure part of the ‘touch contact’ side 104 of the light guide plate. The pedestal portion could be omitted altogether as shown in FIG. 6D, but in this case the attachment surface 102 is in the optical path, and the assembly is likely to be less mechanically robust.

It will be appreciated from FIGS. 6B, 6C and 6D that the redirection elements redirect the divergent light 17 into a plane substantially parallel to the light guide plate 30.

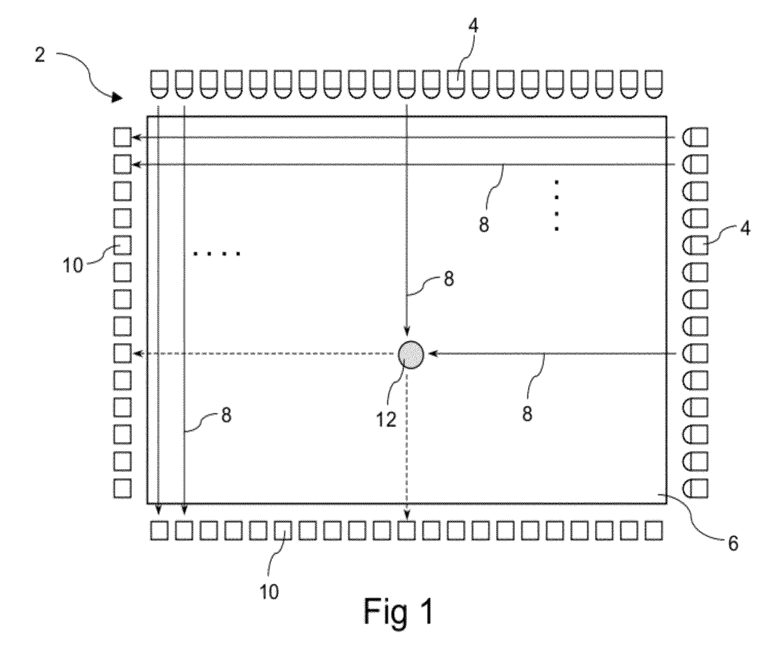

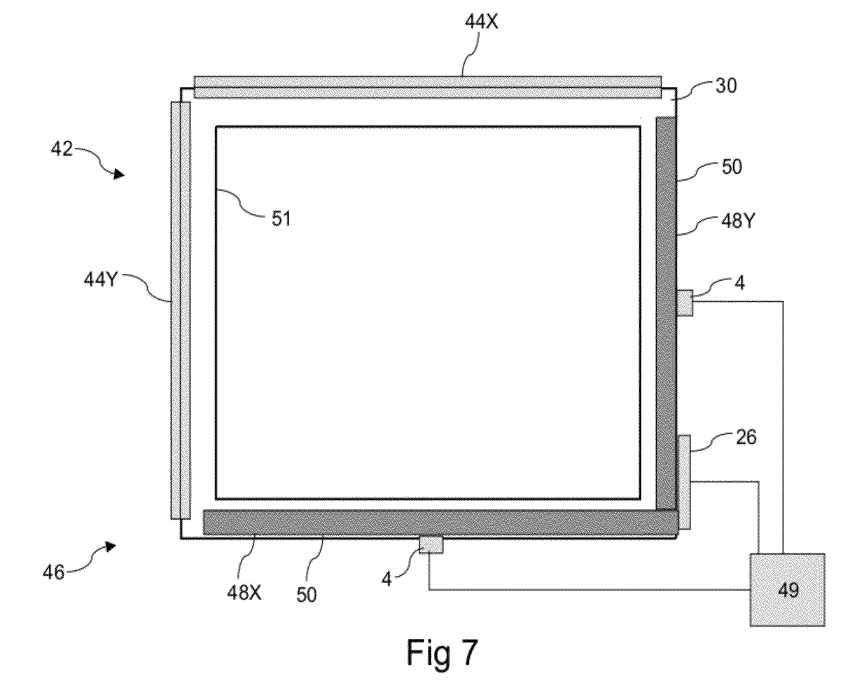

The simplified signal production device 42 can be combined with a system of receive optics, for example an optical waveguide array coupled to one or more multi-element detectors 26 as shown in FIG. 2 or an array of discrete detectors 10 as shown in FIG. 1, to yield a simplified infrared touch screen. In the particular embodiment 46 shown in FIG. 7, the receive optics comprise X, Y waveguide arrays 48X and 48Y formed on separate linear substrates 50 attached to the light guide plate 30 and facing the redirection elements 44X and 44Y, and a multi-element detector 26 optically coupled to the waveguide arrays. In one alternative embodiment the waveguide arrays are formed on a single L-shaped substrate 24 as shown for example in FIG. 2, while in another embodiment the X,Y waveguide arrays are coupled to separate multi-element detectors. FIG. 7 also shows a controller 49 connected to the LEDs and the detector. For simplicity a controller is generally not shown in subsequent illustrated embodiments, but will invariably be present. The boundaries of the viewing area 51 will generally be defined by a protective bezel (not shown) covering the redirection elements and the waveguide arrays.

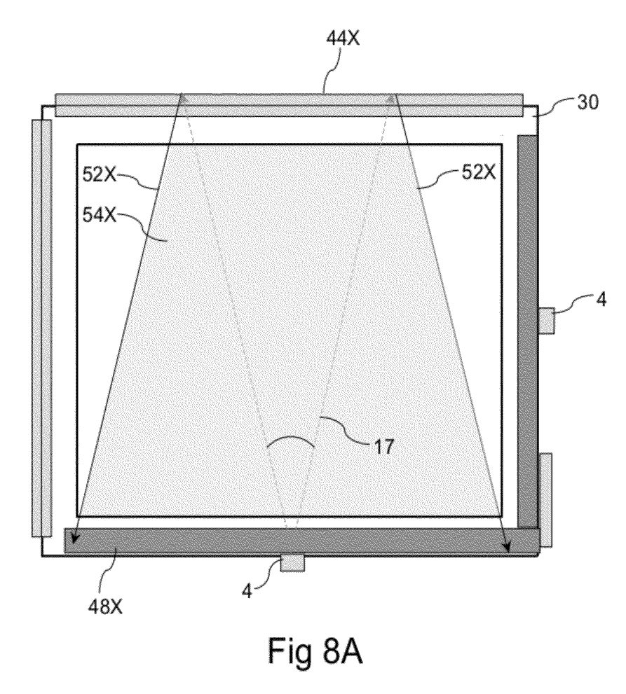

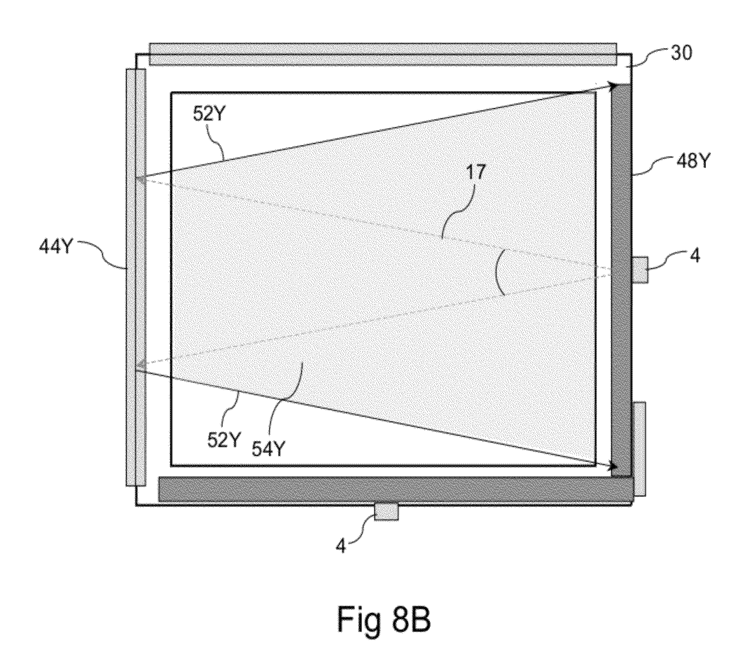

As shown in plan view in FIGS. 8A and 8B, divergent light 17 emitted by the optical sources 4 is guided within the light guide plate 30 before being redirected by specular reflection at the redirection elements 44X and 44Y to form two light sheets 54X and MY that propagate in front of and substantially parallel to the surface of the light guide plate towards the waveguide arrays 48X and 48Y. The two light sheets are preferably co-planar, but may be in spaced apart planes depending on the detailed design of the redirection elements. The light paths 52X and 52Y represent the boundaries of the usable parts of the light sheets 54X and 54Y, i.e. the parts within which a touch object can be detected by a blockage of the respective light sheet, and show that the light sheets continue to diverge as they propagate towards the waveguide arrays.

It will be appreciated that the light launched from the LEDs into the light guide plate should have sufficient divergence for the sensing light sheets to extend across the full width of the corresponding waveguide array. The divergence may be greater than this minimum requirement, i.e. the light sheets 54X and 54Y may extend beyond the indicated boundaries 52X and 52Y, and if the same type of LED is used for both axes then the shorter side at least will be over-filled. Overfilling results in less-than-optimal power efficiency but does not affect the touch detection. Similarly the redirection elements need only be long enough to cover the extent of the diverging light paths. To facilitate assembly, however (i.e. to avoid tight alignment tolerances), it is preferable for the redirection elements to extend along substantially the entire length of the sides of the light guide plate as shown.

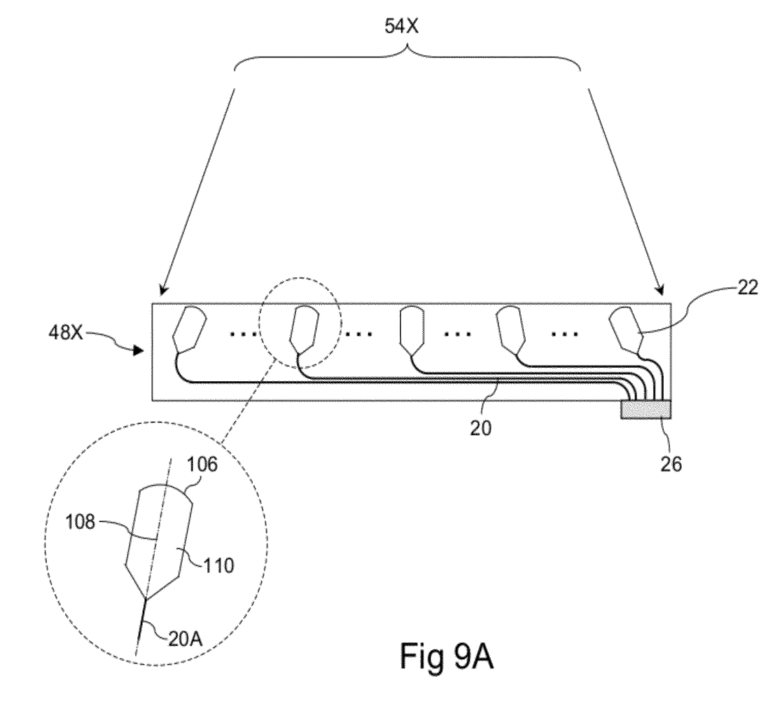

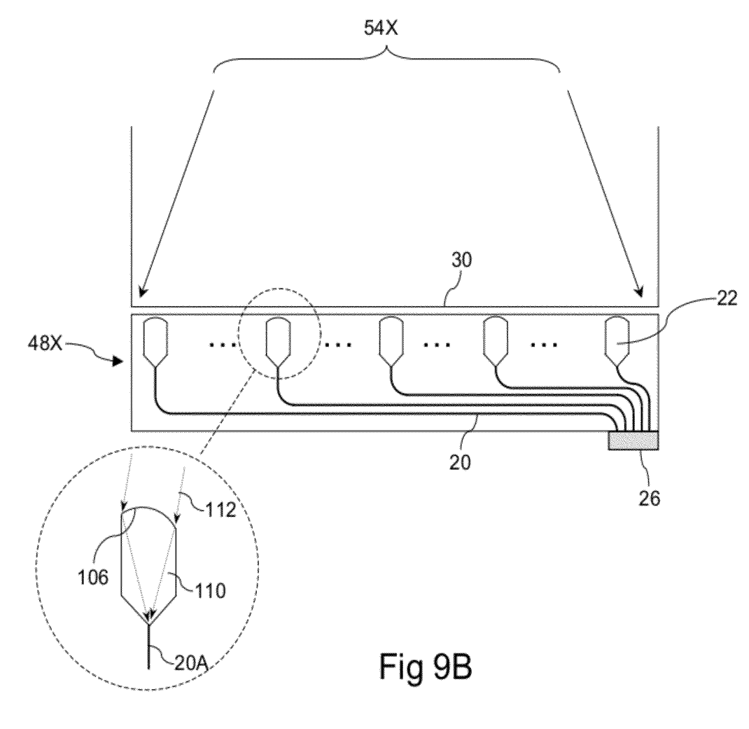

Clearly the waveguide arrays 48X and 48Y need to be adapted to receive portions of diverging light sheets, rather than collimated light sheets 18 as shown in FIG. 2. One possible layout for a waveguide array 48X is illustrated schematically in FIG. 9A, showing a selection of receive waveguides 20 and in-plane lenses 22 angled to receive appropriate portions of the light sheet 54X. In this particular layout the in-plane lenses 22 are symmetric in design, as shown in detail in the inset of FIG. 9A, with the refractive surface 106 and the adjoining waveguide section 20A aligned symmetrically with the axis 108 of the slab waveguide portion 110. Another possible layout for a waveguide array 48X is illustrated schematically in FIG. 9B. In this layout, as shown in detail in the inset of FIG. 9B, the slab waveguide portions 110 and adjoining waveguide sections 20A are each aligned perpendicular to the adjacent edge of the light guide plate 30, and each refractive surface 106 is uniquely designed so as to capture the required portion 112 of the light sheet 54X and focus it into the waveguide. A number of other waveguide layouts will occur to those skilled in the art, the key aspect being that each in-plane lens is designed or oriented to capture a specific portion of the light sheet 54X. A waveguide array 48Y can be configured in analogous fashion.

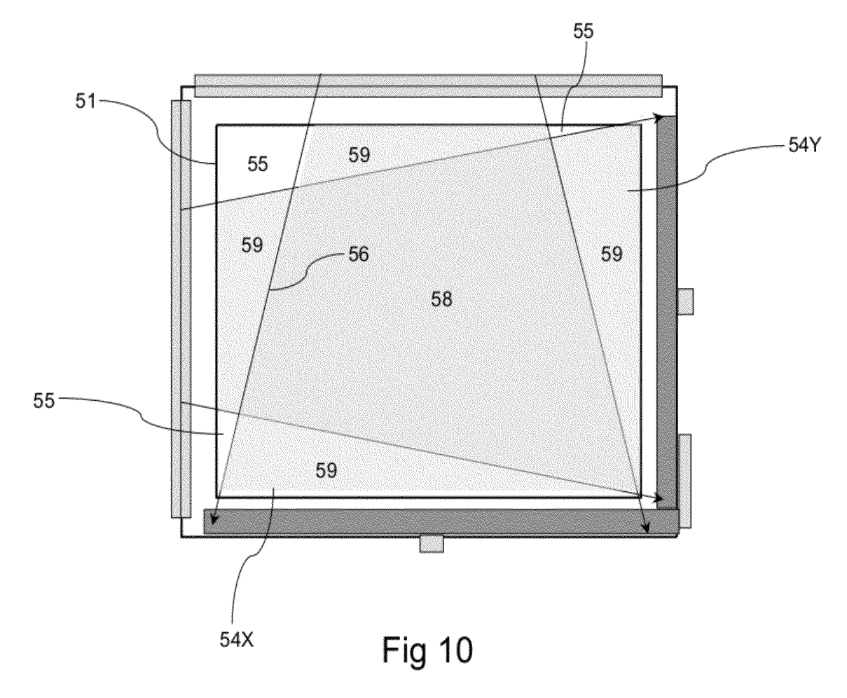

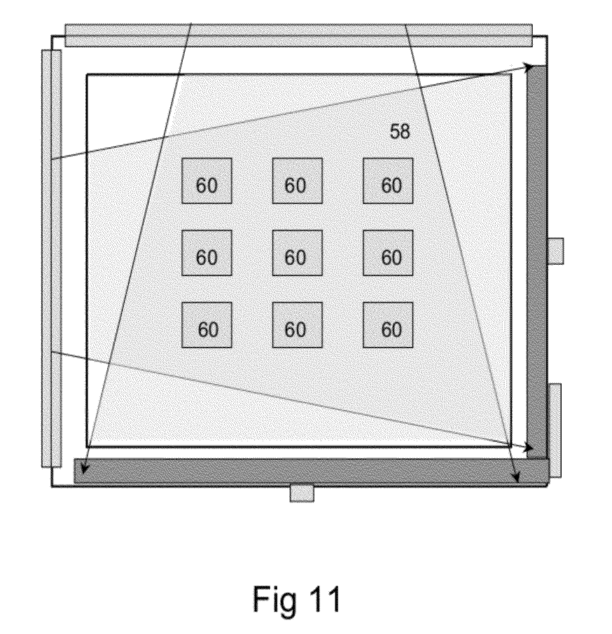

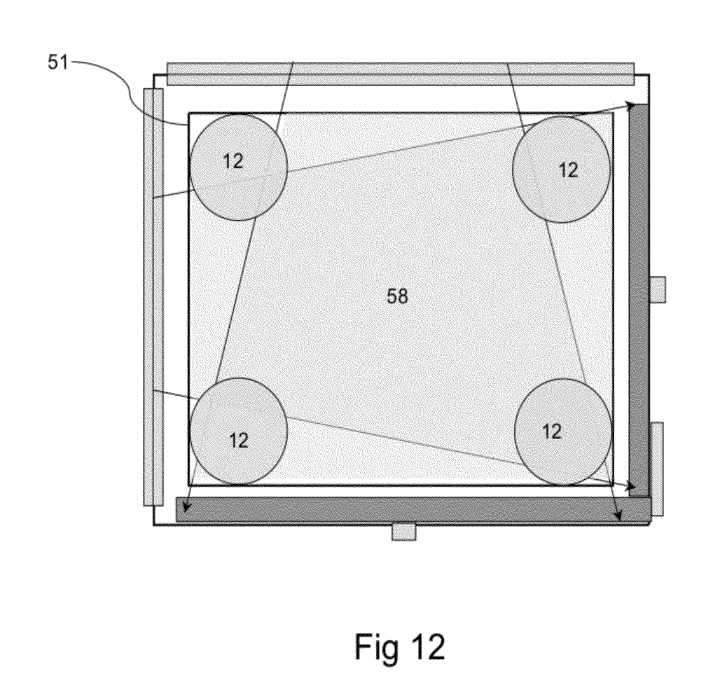

FIG. 10 shows both light sheets 54X and 54Y, with the usable overlap region bounded by the quadrilateral 56 representing the primary touch area 58. So long as a touch object has sufficient overlap with this primary touch area to block a detectable portion of sensing light in both light sheets, determined for example by the waveguide pitch and thresholding algorithms, its location can be determined. In addition there are a number of secondary touch areas 59 with ‘single beam coverage’ where an object can be detected but not accurately located, and a number of small ‘dead zones’ 55 within which an object cannot be detected. Despite the fact that the primary touch area does not cover the entire viewing area 51, there are several situations where this is an acceptable trade-off for the above-described advantages of the simplified configuration. One example, shown in FIG. 11, is an application where a user is required to make a selection from a number of icons 60 arranged to be within the primary touch area 58. Another example is ‘finger-only’ touch on relatively small devices, where the expected touch objects are large enough to be detected and located anywhere within the viewing area. By way of specific example, FIG. 12 shows that for a 30 mm×25 mm viewing area 51 (˜1.5″ diagonal), an 8 mm diameter touch object 12 (representative of a finger touch) will always overlap at least in part with the primary touch area 58, allowing its location to be determined. It will also be appreciated that detection of smaller objects can be guaranteed by reducing the size of the viewing area 51 so that it matches the primary touch area more closely.

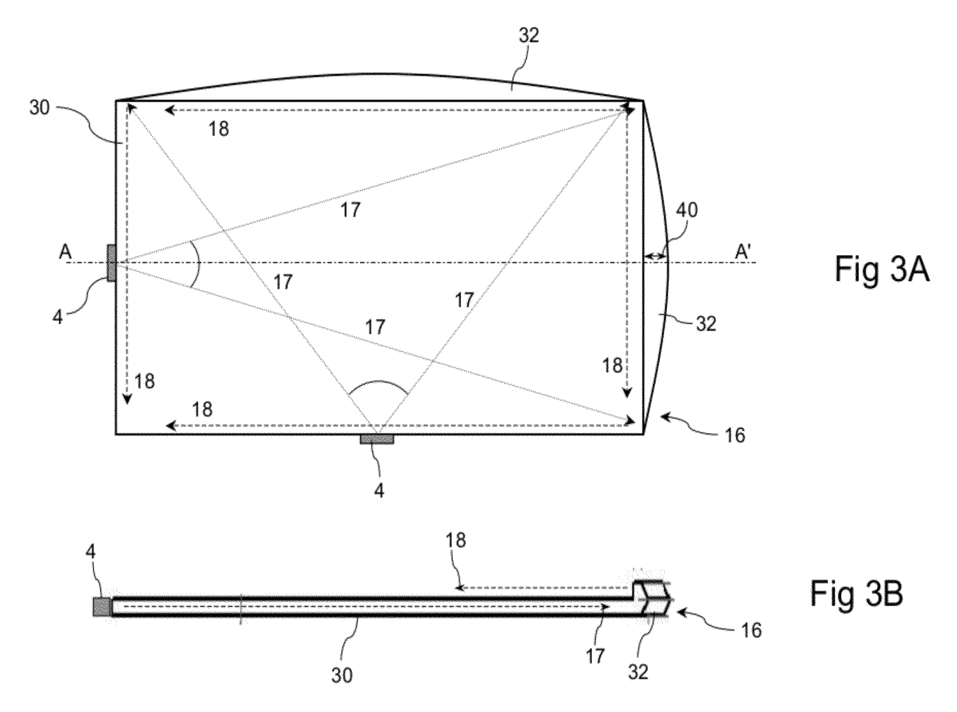

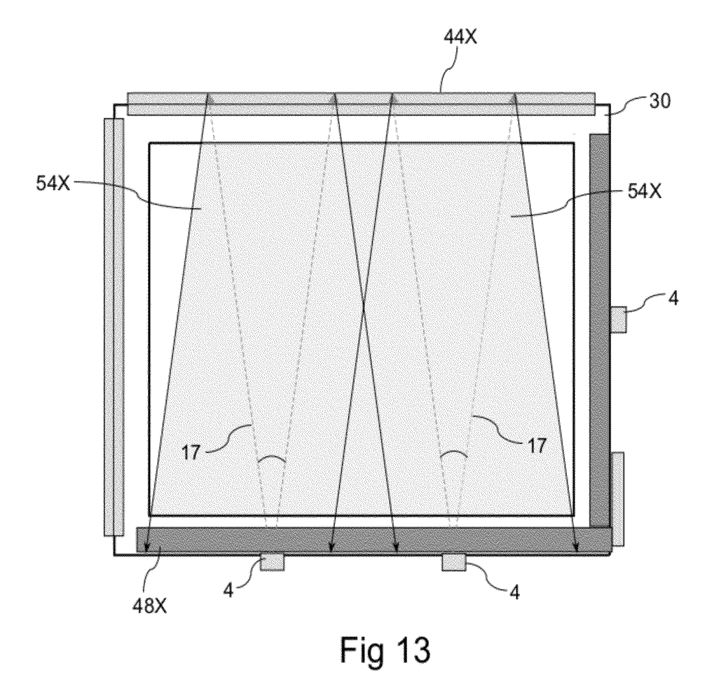

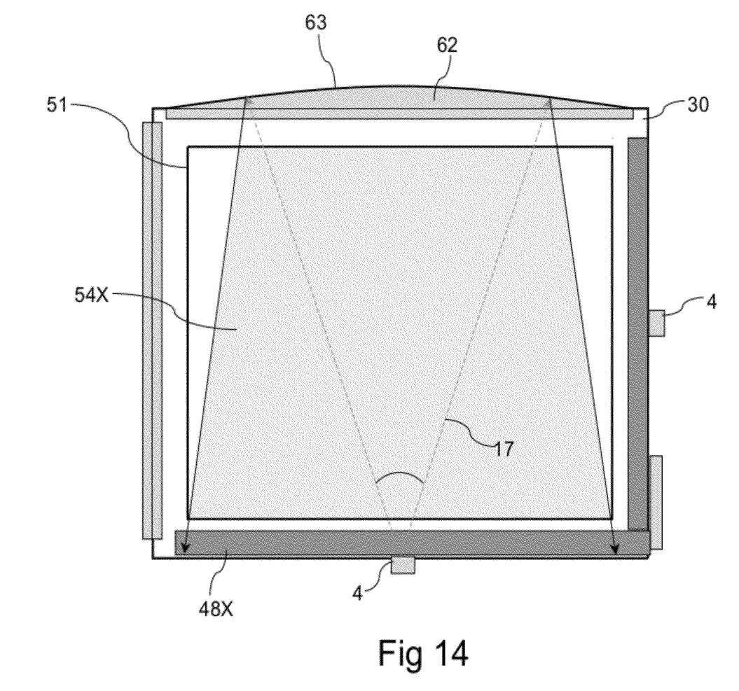

On the other hand for situations where the active touch area does not give sufficient coverage of the viewing area, e.g. for larger viewing areas where finger detection cannot be guaranteed or to guarantee stylus detection, the configuration shown in FIG. 7 can be extended by providing one or both axes with additional LEDs generating additional light sheets 54X as shown for example in FIG. 13. An alternative ‘controlled divergence’ embodiment illustrated in FIG. 14 (showing one axis only) includes a redirection element 62 modified by the addition of a divergence control element 63 having a degree of curvature that reduces the divergence of the light sheet 54X, thereby providing more complete coverage of the viewing area 51. Compared to the parabolic collimation/redirection elements 32 shown in FIG. 3A that completely correct the in-slab divergence of the light paths 17, this modified redirection element 62 will have reduced curvature and will therefore result in reduced bezel width. Either way, it will be seen that the usable fraction of the screen area covered the light sheet(s) 54X in FIG. 13 or 14 is greater than the corresponding fraction in the configuration shown in FIG. 8A.

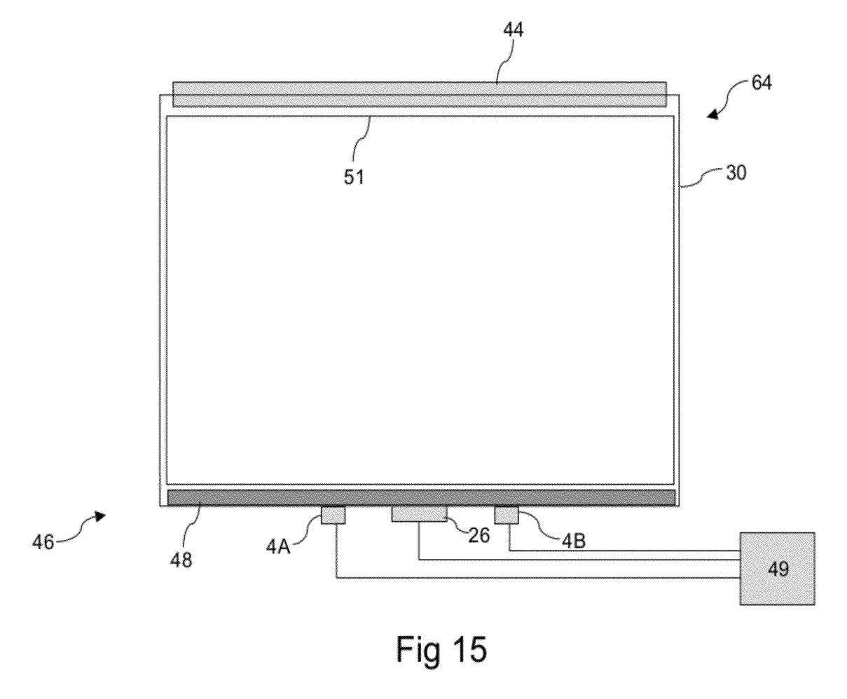

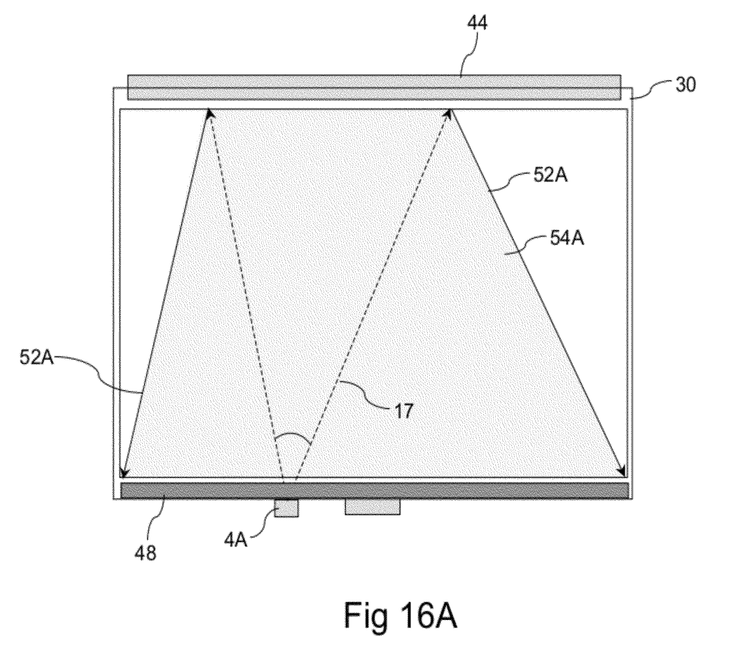

FIG. 15 shows in plan view another embodiment of a simplified infrared touch screen 46, comprising: a simplified signal production device 64; a system of receive optics comprising a receive waveguide array 48 along one side only and optically coupled to a multi-element detector 26; and a controller 49. In this embodiment the simplified signal production device comprises a rectangular light guide plate 30 with a redirection element 44 along one side only, and two optical sources 4A and 4B (e.g. LEDs) spaced apart along the side opposing the redirection element and positioned to launch divergent light into the light guide plate towards the redirection element. In one embodiment the light guide plate is in the form of a glass sheet and the redirection element is in the form of an elongate turning prism, formed of injection moulded or extruded plastic for example, attached to the light guide plate in similar fashion to that shown for example in FIG. 4. The boundaries of the viewing area 51 will generally be defined by a protective bezel (not shown) covering the redirection element and the waveguide array, and it will be evident that this embodiment has minimal bezel width requirements along the left and right sides where there are no optical components.

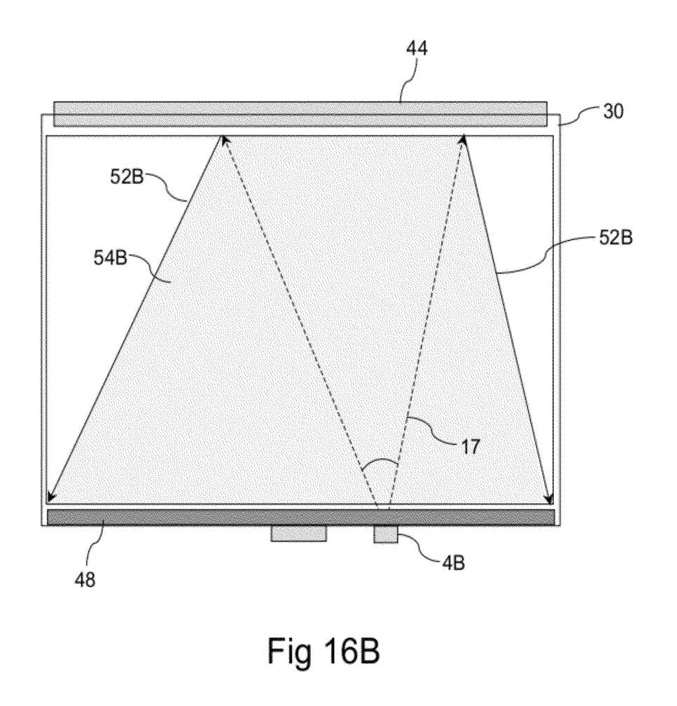

As shown in plan view in FIGS. 16A and 16B, divergent light 17 emitted by the optical sources 4A and 4B is guided within the light guide plate 30 before being redirected by specular reflection at the redirection element 44 to form two light sheets 54A and 54B that propagate in front of and substantially parallel to the surface of the light guide plate towards the waveguide array 48. The light paths 52A and 52B represent the usable boundaries of the light sheets 54A and 54B, within which a touch object can be detected by a blockage of that particular light sheet, and show that the light sheets continue to diverge as they propagate towards the waveguide array. As in the dual axis embodiment described previously with reference to FIGS. 8A and 8B, the light launched from the LEDs into the light guide plate should have sufficient divergence for the sensing light sheets to extend at least across the full width of the waveguide array. Similarly the redirection element need only be long enough to cover the extent of the diverging light paths, but to facilitate assembly it is preferable for it to extend along substantially the entire length of the light guide plate as shown. In certain embodiments the LEDs are angled so as to produce the asymmetric light sheets shown in FIGS. 16A and 16B, but this is unnecessary if the emission sector of each LED is sufficient to over-fill the redirection element.

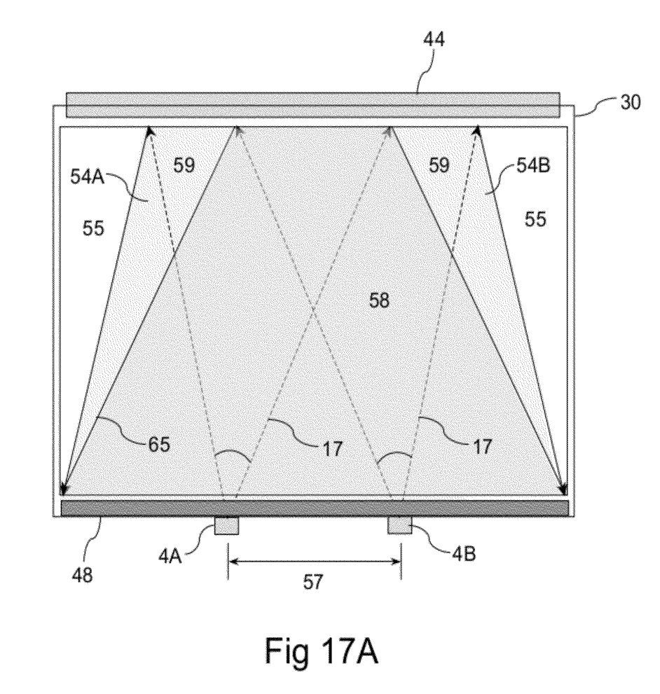

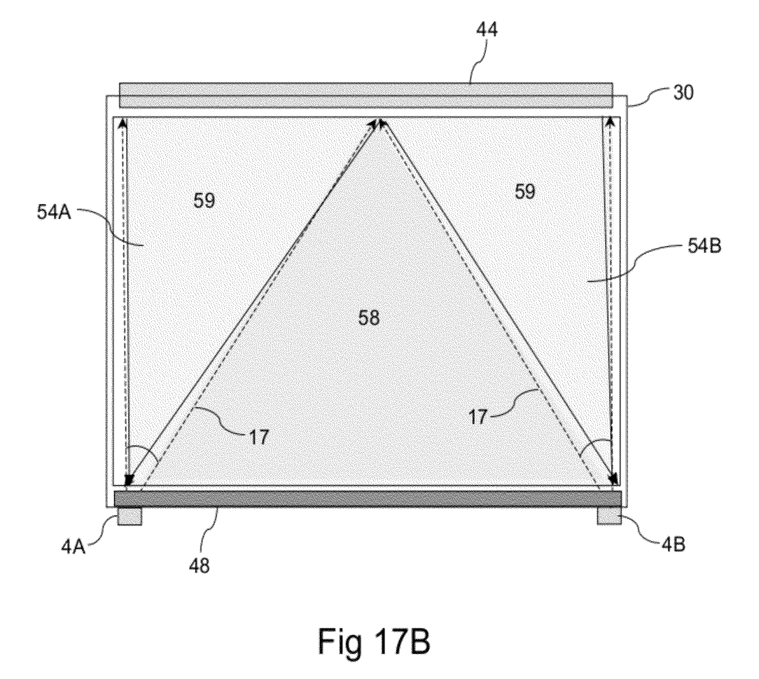

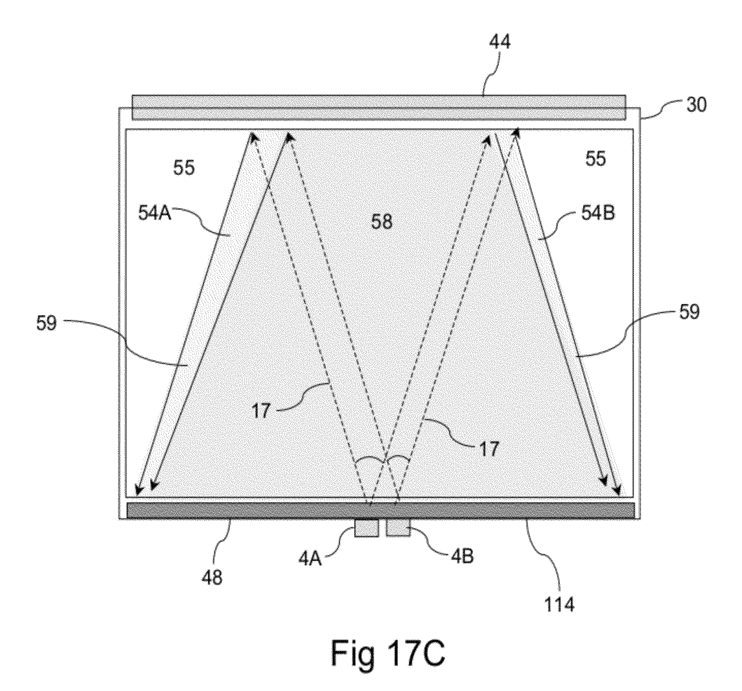

FIG. 17A shows both light sheets 54A and 54B, with the usable overlap region bounded by the trapezium 65 representing the primary touch area 58. So long as a touch object has sufficient overlap with this area to block a detectable portion of sensing light in both light sheets, determined for example by the waveguide pitch and thresholding algorithms, its location can be determined. As in the dual axis embodiment illustrated in FIG. 10, there are also secondary touch areas 59 with single beam coverage and dead zones 55 with no beam coverage. The relative sizes of the primary and secondary touch areas and the dead zones is a design choice that will be determined by the separation 57 between the LEDs 4A and 4B. For example if the LEDs are placed near the corners of the light guide plate 30 as shown in FIG. 17B, there will be minimal dead zones but the secondary touch areas 59 will occupy approximately half of the input area. On the other hand if both LEDs are placed near the centre of the edge 114 as shown in FIG. 17C, there will be minimal secondary touch areas 59. Note however that there needs to be at least some separation between the LEDs to provide the ‘stereoscopic’ pattern of overlapping light sheets so that the location of a touch object within the primary touch area can be determined.

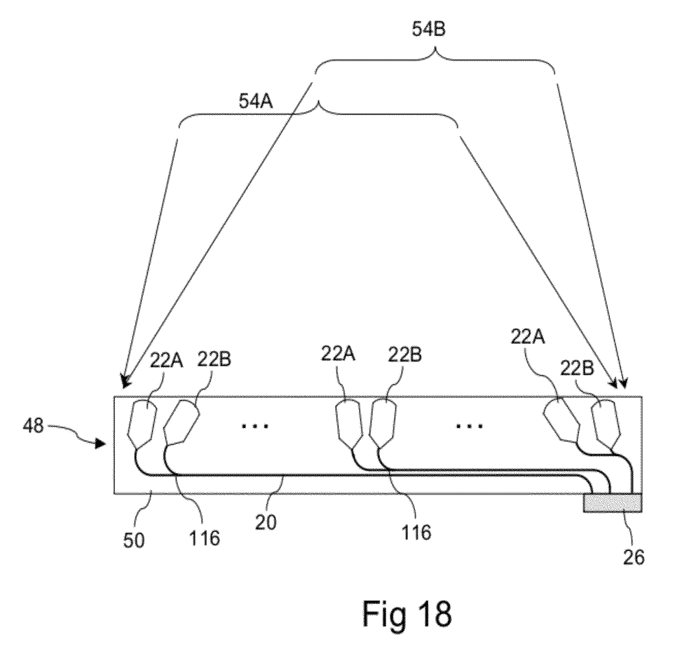

Turning now to consideration of the receive optics, it will be evident that two sub-arrays are required to receive portions of the light sheets 54A and 54B. In certain embodiments the sub-arrays are in the form of interleaved sets of in-plane lenses and waveguides fabricated on a single substrate 50 as shown schematically in FIG. 18, with the in-plane lenses 22A and 22B angled (or designed as shown in FIG. 9B for example) so as to receive portions of the light sheets 54A and 54B. Adjacent ‘A’ and ‘B’ lenses feed received signal light into a single waveguide 20 at a series of Y junctions 116 to reduce the number of waveguides required, e.g. to reduce material costs and waveguide freeway width, with the two optical sources pulsed alternately to provide discrimination between the ‘A’ and ‘B’ light sheets. However this configuration has the disadvantage of a 3 dB loss at every Y junction 116, where 50% of the light captured by the adjacent pairs of ‘A’ and ‘B’ lenses is lost to radiation modes. In an alternative embodiment the Y junctions are omitted, so that the waveguides connected to the ‘A’ and ‘B’ lenses remain separate; this avoids the 3 dB loss but increases the bezel width because of the additional waveguides.

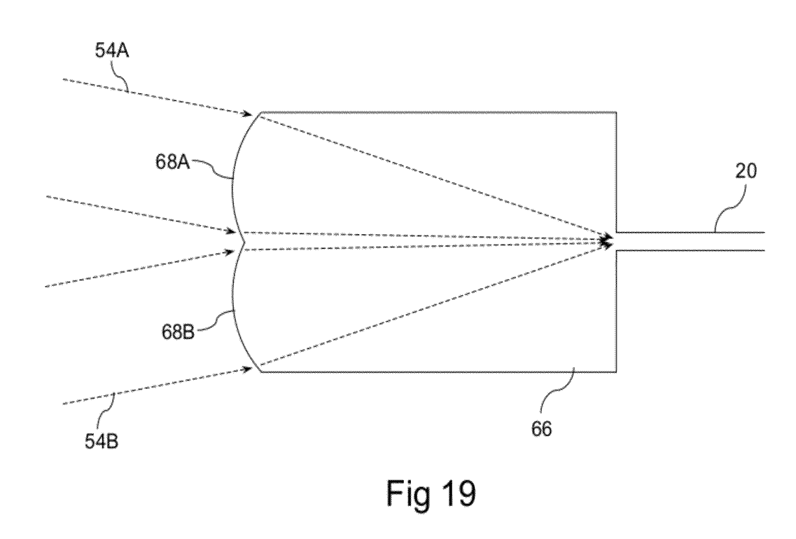

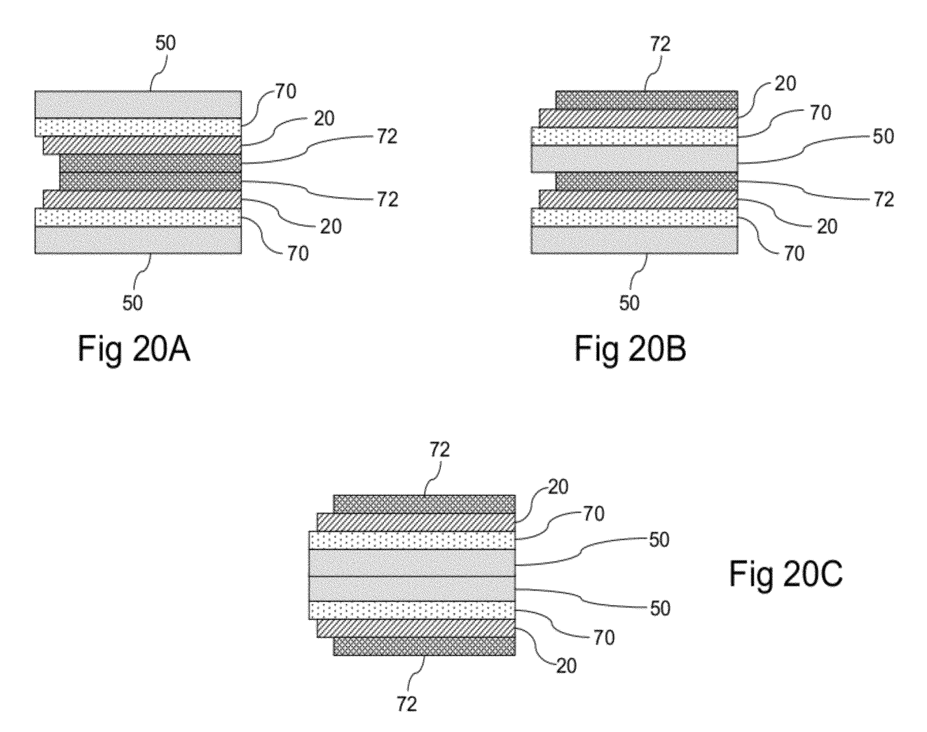

In another alternative embodiment, adjacent ‘A’ and ‘B’ lenses are fabricated together as a composite in-plane lens structure 66 as shown in plan view in FIG. 19, with two focusing elements in the form of refracting facets 68A and 68B focusing portions of the ‘A’ and ‘B’ light sheets 54A and 54B into a single waveguide 20. This avoids the 3 dB loss incurred in the FIG. 18 configuration because both refracting facets focus light within the acceptance angle of the waveguide 20. PCT patent application No PCT/AU2011/000606 discloses several other planar waveguide structures suitable for focusing portions of the ‘A’ and ‘B’ light sheets into a single waveguide, with small design modifications if necessary to compensate for the light sheets being divergent rather than collimated. In yet another embodiment, the ‘A’ and ‘B’ lenses can feed separate waveguide arrays that are optically coupled to separate portions of the multi-element detector 26 or to separate multi-element detectors. In still other embodiments, two receive optics sub-arrays are fabricated on separate substrates 50 that can be stacked waveguide-to-waveguide, waveguide-to-substrate or substrate-to-substrate as shown in side view in FIGS. 20A, 20B and 20C respectively. Lower cladding layers 70 and upper cladding layers 72 provide optical isolation for the waveguide core layers 20, as is usual for integrated optical waveguides.

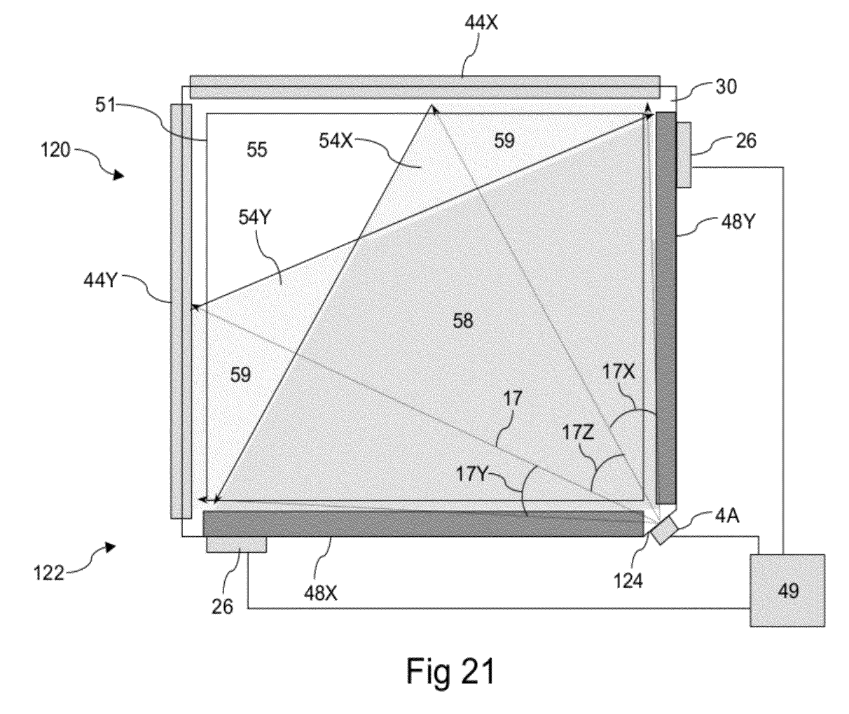

FIG. 21 shows in plan view another embodiment of a simplified infrared touch screen 120, comprising: a simplified signal production device 122; a system of receive optics comprising receive waveguides arrays 48X and 48Y along two adjacent sides of a light guide plate 30 and optically coupled to multi-element detectors 26; and a controller 49. In this embodiment the simplified signal production device 122 comprises a rectangular light guide plate 30 with redirection elements 44X and 44Y along adjacent sides opposing the waveguide arrays, and an optical source 4A (e.g. an LED) positioned proximate to a corner 124 of the light guide plate to launch divergent light 17 into the light guide plate towards the redirection elements. In one embodiment the light guide plate is in the form of a glass sheet and the redirection elements are in the form of elongate turning prisms, formed of injection moulded or extruded plastic for example, attached to the light guide plate in similar fashion to that shown in FIG. 4. The boundaries of the viewing area 51 will generally be defined by a protective bezel (not shown) covering the redirection elements and the waveguide arrays. Preferably the corner 124 is chamfered as shown, to facilitate the positioning of the optical source and the launching of light into the light guide plate.

First and second sectors 17X and 17Y of the divergent light 17 emitted by the optical source 4A and guided within the light guide plate 30 are then redirected by specular reflection at the redirection elements 44X and 44Y to form two light sheets 54X and 54Y that propagate in front of and substantially parallel to the surface of the light guide plate towards the waveguide arrays 48X and 48Y. FIG. 21 also shows the overlap region of the usable parts of the two light sheets representing the primary touch area 58, two secondary touch areas 59 with single beam coverage and a dead zone 55 with no beam coverage. The receive waveguide arrays 48X and 48Y are adapted to receive portions of the diverging light sheets 54X and 54Y, and may for example comprise layouts of in-plane lenses 22 and waveguides 20 structured in similar fashion to the layouts shown in FIG. 9A or 9B.

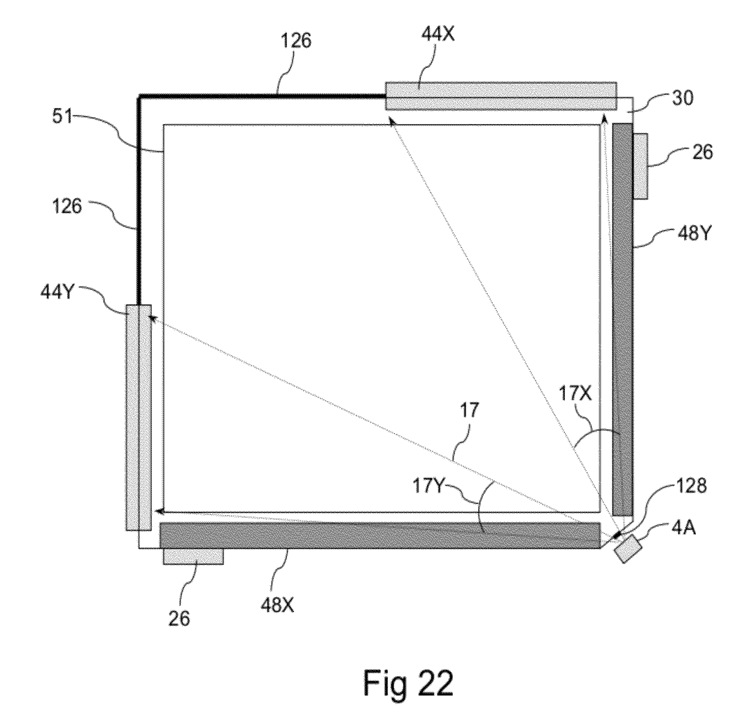

The optical source will ordinarily also emit light within the sector 17Z, which will be lost to the system or be a source of stray light. If desired, e.g. to prevent stray light getting to the receive optics, this unwanted light can be removed by one or more of a number of means shown in FIG. 22, including an absorbing coating 126 on appropriate portions of the light guide plate sides, appropriately shortened redirection elements 44X and 44Y, or a beam stop 128 on an appropriate part of the chamfered corner 124. Alternatively, two optical sources with appropriate emission characteristics could be used, to provide separate illumination of the redirection elements.

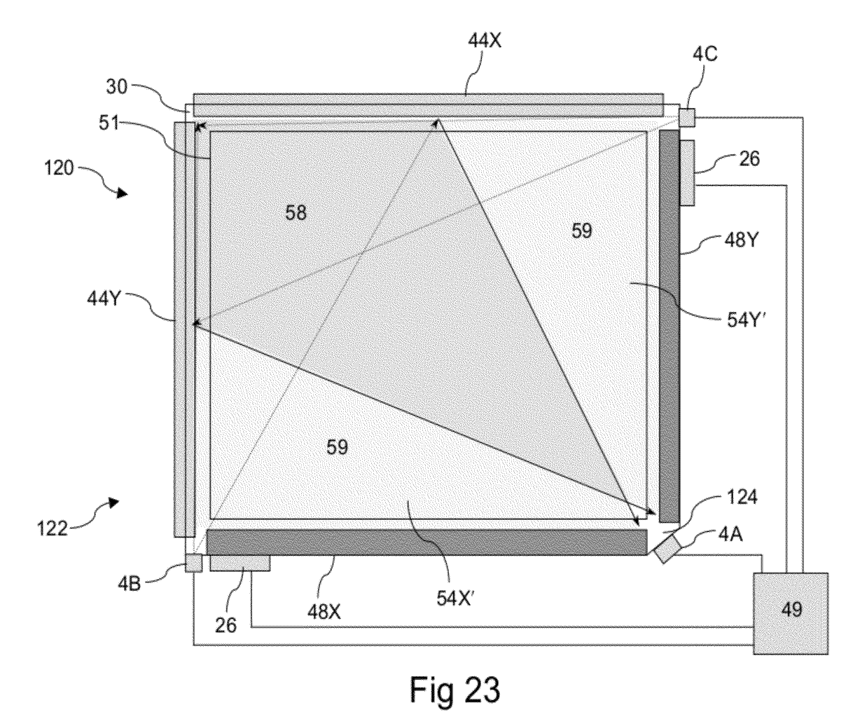

FIG. 23 shows a simplified infrared touch screen 120 similar to that shown in FIG. 21, but with two additional optical sources 4B and 4C positioned proximate to two other corners of the light guide plate 30. Neglecting the optical source 4A for now, these additional optical sources will generate light sheets 54X′ and 54Y′ that have a usable overlap region 58 and two areas 59 with single beam coverage. Comparison with FIG. 21 shows that when all three optical sources are activated the entire viewing area 51 will be covered with overlapping beams, so that a touch object can be detected and located anywhere within the viewing area. Referring back to FIG. 22, the unnecessary middle sector 17Z of the light emitted by the optical source 4A could still be removed if required with a beam stop 128 or by using two optical sources in place of the optical source 4A in the corner 124.

In the embodiment shown in FIG. 23, each of the two waveguide arrays 48X and 48Y is required to receive appropriate portions of two diverging light sheets, and may for example comprise a layout of interleaved in-plane lenses 22A and 22B and waveguides 20 structured in similar fashion to the layout shown in FIG. 18, or an array of composite in-plane lenses 66 and optical waveguides 20 as shown in FIG. 19.

Although the invention has been described with reference to specific examples, it will be appreciated by those skilled in the art that the invention may be embodied in many other forms.

1. A signal production device for a touch screen, said signal production device comprising a transmissive body and a first optical source, wherein said transmissive body comprises:
(a) a substantially planar light guide plate adapted to receive a divergent optical signal from said first optical source and confine and transmit said optical signal; and
(b) a redirection element adapted to redirect said optical signal to produce a first sheet of light propagating and diverging in a first plane substantially parallel to said light guide plate.

2. A signal production device according to claim 1, wherein said redirection element is positioned along a first side of said light guide plate, and said first optical source launches said divergent optical signal through a second, opposing side of said light guide plate towards said redirection element such that said first sheet of light overlies at least part of a surface of said light guide plate.

3. A signal production device according to claim 2, further comprising a second optical source spaced apart from said first optical source and positioned to launch a second divergent optical signal through said second side of said light guide plate towards said redirection element so as to produce a second sheet of light propagating and diverging in said first plane, wherein said second sheet of light overlies at least part of said surface and has a substantial overlap region with said first sheet of light.

4. A signal production device according to claim 2, further comprising: a second redirection element positioned along a third side of said light guide plate; and a second optical source positioned to launch a second divergent optical signal through a fourth side of said light guide plate towards said second redirection element so as to produce a second sheet of light propagating and diverging in a second plane substantially parallel to said light guide plate, wherein said second sheet of light overlies at least part of said surface and has a substantial overlap region with said first sheet of light.

5. A signal production device according to claim 4, wherein said first and second planes are the same plane.

6. (canceled)

7. A signal production device according to claim 6, wherein said redirection element is an elongate turning prism.

8. A signal production device according to claim 1, wherein said redirection element further comprises a divergence control element adapted to reduce the divergence of said first sheet of light in said first plane.

9.-10. (canceled)

11. A signal production device for a touch screen, said signal production device comprising: a substantially planar light guide plate; first and second redirection elements positioned along adjacent first and third sides of said light guide plate, said first and third sides extending from a first corner of said light guide plate; and a first optical source positioned proximate a second corner of said light guide plate, opposite said first corner, wherein:
said first optical source launches a divergent first optical signal into said light guide plate towards said first and second redirection elements, such that said first redirection element redirects a first part of said first optical signal to produce a first sheet of light propagating and diverging in a first plane substantially parallel to said light guide plate, and said second redirection element redirects a second part of said first optical signal to produce a second sheet of light propagating and diverging in a second plane substantially parallel to said light guide plate, wherein said first and second sheets of light each overlie at least part of a surface of said light guide plate and have a substantial overlap region.

12. A signal production device according to claim 11, further comprising second and third optical sources positioned proximate to third and fourth corners of said light guide plate, wherein said second optical source launches a divergent second optical signal into said light guide plate towards said first redirection element to produce a third sheet of light propagating and diverging in said first plane, and said third optical source launches a divergent third optical signal into said light guide plate towards said second redirection element to produce a fourth sheet of light propagating and diverging in said second plane, wherein said third and fourth sheets of light each overlie at least part of said surface.

13. A signal production device according to claim 11, wherein said first and second planes are the same plane.

14. A touch screen comprising: a signal production device adapted to produce a first diverging sheet of light; and a system of receive optics for receiving portions of said first sheet of light, wherein said signal production device comprises:
(a) a substantially planar light guide plate adapted to receive a divergent optical signal from a first optical source and confine and transmit said optical signal; and
(b) a redirection element adapted to redirect said optical signal to produce a first sheet of light propagating and diverging towards said system of receive optics in a first plane substantially parallel to said light guide plate.

15. A touch screen according to claim 14, wherein said redirection element is positioned along a first side of said light guide plate, said system of receive optics is positioned along a second, opposing side of said light guide plate, and said first optical source launches said divergent optical signal through said second side towards said redirection element such that said first sheet of light overlies at least part of a surface of said light guide plate.

16. A touch screen according to claim 14, wherein said system of receive optics comprises an optical waveguide array and at least one multielement detector, wherein the waveguides in said array are adapted to receive portions of said first sheet of light and conduct said portions to said at least one multi-element detector.

17. A touch screen according to claim 15, wherein said signal production device further comprises a second optical source spaced apart from said first optical source and positioned to launch a second divergent optical signal through said second side of said light guide plate towards said redirection element so as to produce a second sheet of light propagating and diverging towards said system of receive optics in said first plane, wherein said second sheet of light overlies at least part of said surface and has a substantial overlap region with said first sheet of light.

18. A touch screen according to claim 17, wherein said system of receive optics comprises an optical waveguide array and at least one multi-element detector, wherein the waveguides in said array are adapted to receive portions of said first and second sheets of light and conduct said portions to said at least one multi-element detector.

19. A touch screen according to claim 18, wherein said optical waveguide array comprises interleaved first and second sets of in-plane lenses respectively adapted to receive portions of said first and second sheets of light and focus said portions into corresponding first and second sets of optical waveguides.

20. A touch screen according to claim 19, wherein each pair of adjacent first and second optical waveguides feeds into a common waveguide.

21. A touch screen according to claim 18, wherein said optical waveguide array comprises an array of composite in-plane lenses with associated optical waveguides, wherein each said composite in-plane lens comprises first and second focusing elements adapted to receive portions of said first and second sheets of light and focus said portions into said associated waveguide.

22.-24. (canceled)

25. A touch screen according to claim 15, wherein said signal production device further comprises: a second redirection element positioned along a third side of said light guide plate; and a second optical source positioned to launch a second divergent optical signal through a fourth side of said light guide plate towards said second redirection element so as to produce a second sheet of light propagating and diverging towards said system of receive optics in a second plane substantially parallel to said light guide plate, wherein said second sheet of light overlies at least part of said surface and has a substantial overlap region with said first sheet of light.

26. A touch screen according to claim 25, wherein said system of receive optics comprises one or more optical waveguide arrays and at least one multielement detector, wherein the waveguides in said one or more arrays are adapted to receive portions of said first and second sheets of light and conduct said portions to said at least one multi-element detector.

27.-45. (canceled)
